(19) United States
(12) Patent Application Publication
(10) Pub. No.: US 2017/0093458 A1
(43) Pub. Date: Mar. 30, 2017

(54) ONLINE RESIDUAL SIDE BAND (RSB) CALIBRATION UTILIZING A FREQUENCY CORRECTION CHANNEL (FCCH)

(71) Applicant: QUALCOMM Incorporated, San Diego, CA (US)

(72) Inventors: Hassan Rafique, Basingstoke (GB); Divaydeep Sikri, Woking (GB)

(21) Appl. No.: 14/864,070

(22) Filed: Sep. 24, 2015

(51) Int. Cl. H04B 1/68; H04L 27/36

(52) U.S. Cl. CPC H04B 1/68; H04L 27/366

(57) ABSTRACT

In some examples, a method and apparatus for wireless communication are disclosed. A wireless user equipment (UE) may receive an over-the-air tone pilot and apply the received pilot to a mixer. The mixer may mix the pilot with a local tone to generate a baseband signal. Here, the UE may determine an estimate of one or more parameters corresponding to a residual side band (RSB) in the baseband signal resulting from the mixer, and may accordingly apply the estimated one or more parameters to compensate for the RSB. The estimated RSB parameters may be refreshed online, by taking samples of the over-the-air tone pilot at a suitable refresh rate.

### TECHNICAL FIELD

Aspects of the present disclosure relate generally to communications systems, and more particularly, to the calibration of an imperfect mixer circuit to reduce residual side band (RSB) by sampling and utilizing an over-the-air tone pilot signal, such as a frequency correction channel (FCCH).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is a global system for mobile (GSM) network, which utilizes a GSM air interface.

In any wireless communication system, information is generally transmitted by modulating a carrier signal at a desired carrier frequency with a baseband information signal. When a receiving device receives the signal, it typically applies the received signal to a mixer to mix with a local oscillator at the carrier frequency, to downconvert the signal to its baseband component.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method of wireless communication operable at a user equipment (UE) is disclosed. The method includes receiving an over-the-air tone pilot, applying the received over-the-air tone pilot to a mixer for mixing the tone pilot with a local tone to generate a baseband signal, determining an estimate of one or more parameters corresponding to a residual side band (RSB) in the baseband signal resulting from the mixer, and applying the estimated one or more parameters to compensate for the RSB.

In another example, a UE configured for wireless communication is disclosed. The UE includes at least one processor, a transceiver communicatively coupled to the at least one processor, and a memory communicatively coupled to the at least one processor. Here, the at least one processor and the memory are configured to receive an over-the-air tone pilot, to apply the received over-the-air tone pilot to a mixer for mixing the tone pilot with a local tone to generate a baseband signal, to determine an estimate of one or more parameters corresponding to a residual side band (RSB) in the baseband signal resulting from the mixer, and to apply the estimated one or more parameters to compensate for the RSB.

In another example, another UE configured for wireless communication is disclosed. The UE includes means for receiving an over-the-air tone pilot, means for applying the received over-the-air tone pilot to a mixer for mixing the tone pilot with a local tone to generate a baseband signal, means for determining an estimate of one or more parameters corresponding to a residual side band (RSB) in the baseband signal resulting from the mixer, and means for applying the estimated one or more parameters to compensate for the RSB.

In yet another example, a computer-readable medium storing computer-executable code is disclosed. The computer-readable medium includes instructions for causing a UE to receive an over-the-air tone pilot, to apply the received over-the-air tone pilot to a mixer for mixing the tone pilot with a local tone to generate a baseband signal, to determine an estimate of one or more parameters corresponding to a residual side band (RSB) in the baseband signal resulting from the mixer, and to apply the estimated one or more parameters to compensate for the RSB.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of an ideal I-Q mixer.

FIG. 2 is a block diagram illustrating an example of a mismatched or non-ideal I-Q mixer.

FIG. 3 is a block diagram illustrating a simplified algorithm for estimating residual side band (RSB) parameters and utilizing the estimated RSB parameters for RSB compensation in accordance with some aspects of the disclosure.

FIG. 4 is a chart showing an exemplary output of an imperfect mixer, including a desired signal component and an RSB component.

FIG. 5 is block diagram conceptually illustrating an example of a telecommunications system according to some aspects of the disclosure.

FIG. 6 is a conceptual diagram illustrating an example of an access network according to some aspects of the disclosure.

FIG. 7 is a block diagram illustrating an example of a hardware implementation for a user equipment employing a processing system according to some aspects of the disclosure.

FIG. 8 is a block diagram illustrating an example for estimating RSB parameters according to some aspects of the disclosure.

FIG. 9 is a flow chart illustrating an algorithm for estimating RSB parameters, and utilizing the estimated RSB parameters for compensating the RSB according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

In a typical radio frequency (RF) wireless communication device, a mixer is frequently found. A mixer, broadly, is an electronic device that mixes or combines two or more signals into a composite, combined, or mixed signal. Mixers may be adders or multipliers, or may implement other mathematical relationships between the mixer's input and output. According to various examples described below, relating to a multiplier, a mixer may mix an information signal with a locally generated tone (e.g., a local oscillator or LO). Such a mixer may be utilized as an upconversion mixer or a downconversion mixer depending on the implementation. In some examples, a downconversion mixer may be utilized to mix a received information signal y(t) with an LO at the carrier frequency f_{c}(t) in order to bring the information signal down to baseband.

According to various aspects of the present disclosure the mixer may be an I-Q mixer, wherein an input information signal y(t) may be split and mixed with two out-of-phase and generally orthogonal LO signals. Such an I-Q mixer is useful when it is known or assumed that the information signal y(t) includes an in-phase (I) component and an orthogonal quadrature (Q) component, typical for the transmission of information in many modern wireless communication systems. For example, the information signal may be represented as follows:

y(t)=I(t)cos(2πf_{c}t)−Q(t)sin(2πf_{c}t) (1)

That is, by utilizing the I-Q mixer, the information signal y(t) may be broken down into its I and Q components at baseband.

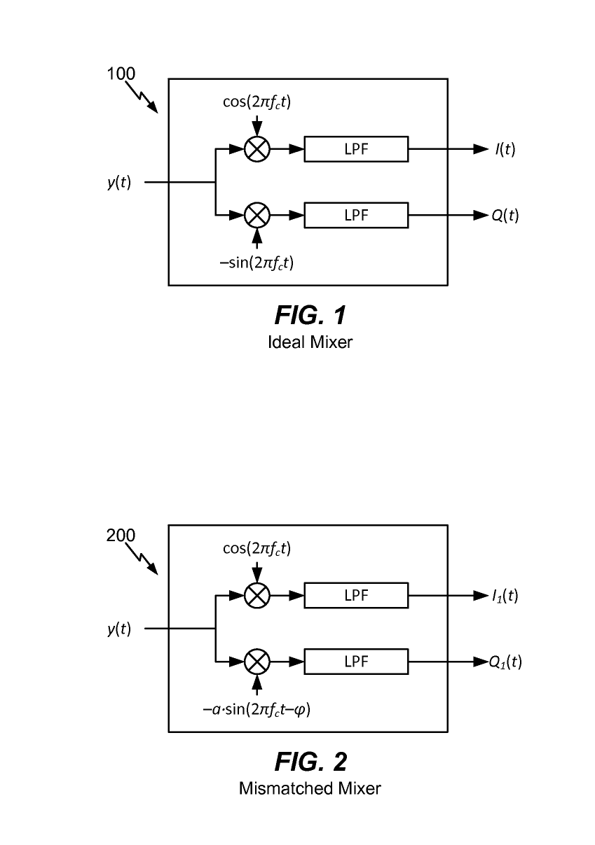

In theory, the mixer may be an ideal mixer. An ideal mixer mixes the information signal y(t) with a sine function and with a cosine function, each having precisely the same carrier frequency f_{c}(t) as the information signal y(t), and the same amplitude as one another. For example, FIG. 1 illustrates an ideal I-Q mixer 100. Here, the ideal mixer 100 splits the input information signal y(t) and mixes it with a first LO having a function cos(2πf_{c}t), and with a second LO having a function −sin(2πf_{c}t). Accordingly, with the ideal mixer illustrated in FIG. 1, if the second output is considered to be the imaginary (quadrature) component, then the output function:

s(t)=I(t)+jQ(t) (2)

That is, s(t) represents the baseband component of the input information signal y(t), having been mixed down to baseband from the carrier frequency f_{c}(t)

However, in general such an ideal mixer may not be achievable in a real-world implementation. Variations in precision in the generation of LO frequencies, and variations in their respective amplitudes, may cause the mixer to be imperfect. According to various aspects of the present disclosure, an imperfect mixer may be a mixer having a mismatch with respect to amplitude and/or phase in its I and Q branches.

FIG. 2 is a block diagram illustrating an imperfect I-Q mixer 200 according to an aspect of the present disclosure. The configuration of the imperfect mixer 200 is largely the same as the ideal mixer 100. However, with the imperfect, mismatched mixer 200 as illustrated in FIG. 2, the mismatch may be represented by the difference in phase (φ) and the difference in amplitude (α) between branches of the mixer (i.e., the cosine function and the sine function corresponding to the LO signals mixed with the input information signal y(t)). Referring to FIG. 2, and assuming the same input information signal y(t) described above in equation (1), the output s₁(t) of the imperfect mixer can be characterized as follows.

s₁(t)=I(t)+jα(l(t)sin φ+Q(t)cos φ) (3)

By applying Euler's identity to this function,

$${s}_{1} ( t ) = I ( t ) = j a ( I ( t ) ( \frac{{e}^{jϕ} - {e}^{- jϕ}}{2 j} ) + Q ( t ) ( \frac{{e}^{jϕ} + {e}^{- jϕ}}{2} ) ) \qquad ( 4 )$$

This can be simplified as follows:

$${s}_{1} ( t ) = ( \frac{1 + a {e}^{jϕ}}{2} ) ( I ( t ) + jQ ( t ) ) + ( \frac{1 - a {e}^{- jϕ}}{2} ) ( I ( t ) - jQ ( t ) ) \qquad ( 5 )$$

This can be written in terms of the desired output from an ideal mixer s(t) as follows:

s₁(t)=As(t)+Bs*(t) (6)

$$\begin{matrix}A = \frac{1 + a {e}^{jϕ}}{2} & ( 7 ) \\ B = \frac{1 - a {e}^{- jϕ}}{2} & ( 8 )\end{matrix}$$

With these complex gains applied to the signal that would be the output of the ideal mixer s(t), and its complex conjugate s*(t), a residual side band (RSB) may be seen as an undesired output of the imperfect mixer 200.

A residual side band or RSB is generally a signal self-image caused by an I-Q imbalance of the mismatched, imperfect mixer 200. This RSB may be a signal having a generally smaller amplitude than the desired signal, appearing at the negative of the frequency of the desired signal. It may be observed, as detailed further below, that the RSB can be fully characterized in accordance with the theoretical desired output s(t) of an ideal mixer, and the parameters α and φ that characterize the mismatched mixer.

In general, the characteristics of the RSB may vary with various factors or parameters, such as the distance of the RSB from the LO frequency, the band utilized for communication, the gain state, and the temperature of the mixer.

An RSB is broadly an undesirable aspect of a mixer. For example, the existence of the RSB may result in an increase in bit errors in a wireless communication system.

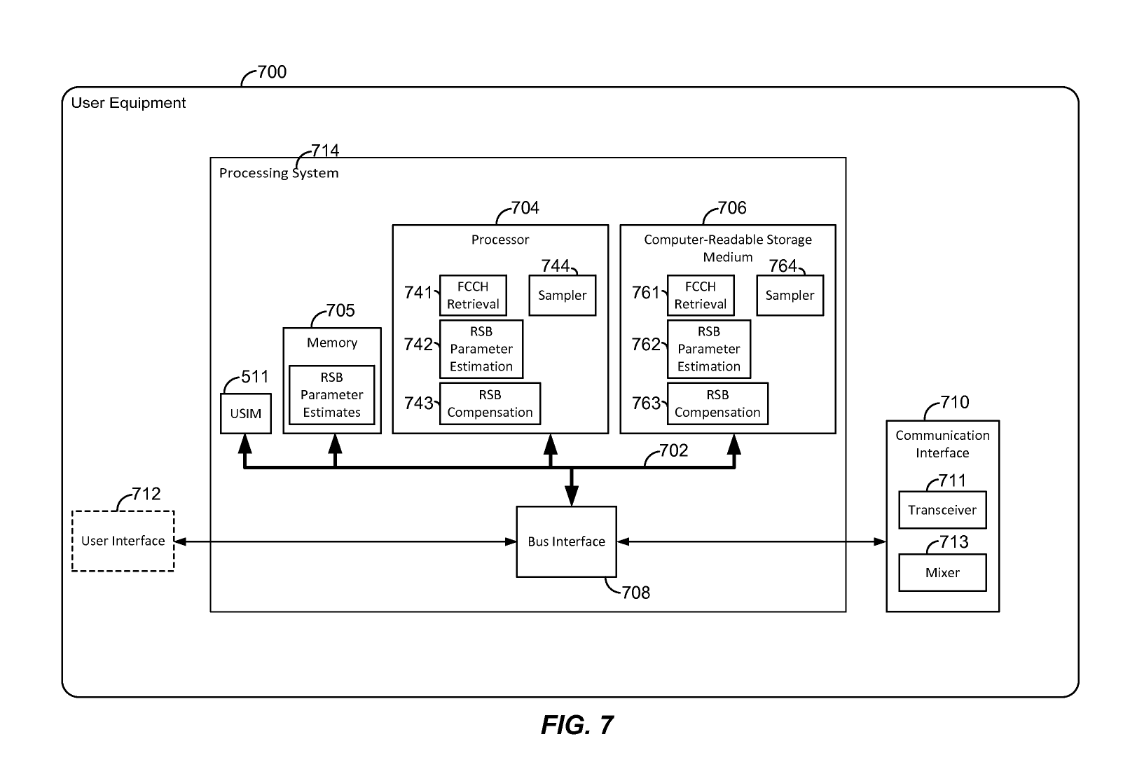

Thus, according to an aspect of the present disclosure, a wireless communication device, such as a user equipment or UE 700 (see FIG. 7) may estimate one or more RSB parameters (e.g., α and φ) and may apply these estimated parameters to an imperfectly mixed information signal. Accordingly, the device may compensate for the RSB to reduce its negative impact, e.g., reducing bit errors in a wireless communication system.

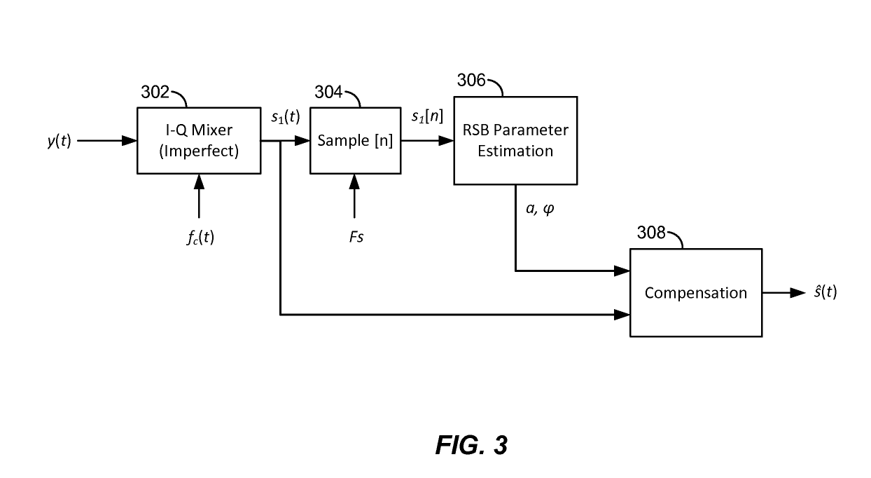

FIG. 3 is a block diagram schematically illustrating certain aspects of the present disclosure, providing for the estimation of RSB parameters, and the use of these estimated RSB parameters for compensation of the RSB resulting from an imperfect mixer.

As illustrated in FIG. 3, an information signal y(t) may be provided to an imperfect I-Q mixer 302. Here, the mixer 302 may be the same as the imperfect mixer 200 described above and illustrated in FIG. 2, with a mismatch in the amplitude/phase of its I and Q branches. The information signal y(t) may in some examples be characterized as a complex exponential tone having a frequency f₀ Hz, modulated by a carrier at frequency f_{c}. That is:

y(t)= [symbol] (ke^{j2πf}^{₀}^{t}*e^{j2πf}^{_{c}}^{t}) (9)

Here, [symbol] (x) represents the real part of x, and k represents the amplitude of the information signal y(t). In one particular aspect of the disclosure, the information signal y(t) may be a sample of the frequency correction channel (FCCH) broadcast in a GSM network. Further discussion of the use of the FCCH for generation of RSB parameter estimates is provided below.

With this input y(t) into the imperfect mixer 302, the output of the imperfect mixer 302 may be represented as:

s₁(t)=kAe^{j2πf}^{₀}^{t}+k*Be^{j2πf}^{₀}^{t}+n(t) (10)

Here, (x*) represents the complex conjugate of x, and n(t) represents a noise function. Further, A and B are complex parameters described above. According to an aspect of the present disclosure, this equation may be utilized to estimate the RSB parameters α and φ.

The output of the imperfect mixer 302 s₁(t) may be represented in the frequency domain according to the equation:

S₁(f)=kAδ(f−f₀)+k*Bδ(f+f₀)+N(f) (11)

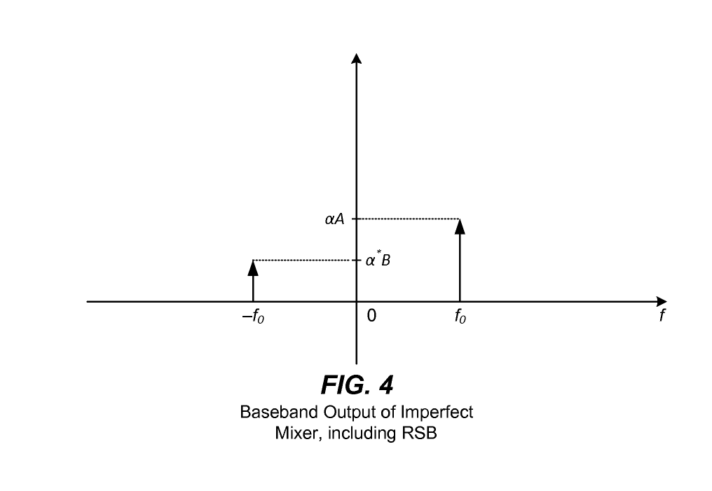

Here, δ(x) represents a delta or impulse function corresponding to an impulse of unit height. FIG. 4 is a chart illustrating a frequency domain representation of the output S₁(f) of the imperfect mixer 302 when the input signal corresponds to a tone. Note that the imperfect mixer 302 downconverts the input information signal y(t) to baseband. In the frequency domain, the energy of the signal S₁(f) may be represented by two tones such that the energy of the baseband signal, and its self-image, are at frequency f₀ Hz and at −f₀ Hz, with amplitude kA and k*B, respectively. These amplitude parameters kA and k*B will be discussed below and correspond to the parameters M₁ and M₂, respectively.

According to an aspect of the present disclosure, described in further detail below, a computationally straightforward approach may mathematically manipulate the imperfectly mixed information signal s₁(t) to obtain the parameters M₁ and M₂. Accordingly, these parameters may be utilized to derive the RSB parameters α and φ, as described below.

Referring once again to FIG. 3, in order to facilitate this process, sampler 304 may sample the mixed information signal s₁(t) at a sampling rate Fs, in order to generate a discrete-time version of the mixed information signal s₁[n]. (Here, n represents a sample index.) RSB parameter estimator 306 may then mathematically estimate one or more parameters (e.g., α and φ) corresponding to the RSB in accordance with the mixed information signal s₁[n]. Further details regarding the calculations performed for RSB parameter estimation are described below.

The illustrated RSB parameter estimator 306 sends as its outputs RSB parameter estimates α and φ. A compensator 308 may utilize the RSB parameter estimates α and φ to compensate the imperfectly mixed information signal s₁(t) to generate a compensated mixed information signal ŝ(t). Here, the compensated mixed information signal ŝ(t) may be a close approximation to, or the same as, the output of the ideal mixer s(t). Further details of the compensation process are provided below, but in brief, the RSB parameter estimates α and φ may be utilized in coordination with the equation characterizing the output of the imperfect mixer 302, and this equation may be mathematically solved for the theoretical output of an ideal mixer.

Accordingly, by utilizing the RSB parameter estimates and compensating for the RSB, aspects of the present disclosure can function to mitigate negative effects of an imperfect mixer 302, e.g., by reducing a bit error rate.

According to some aspects of the disclosure, a device performing RSB parameter estimation and compensation may be configured to operate in a GSM network.

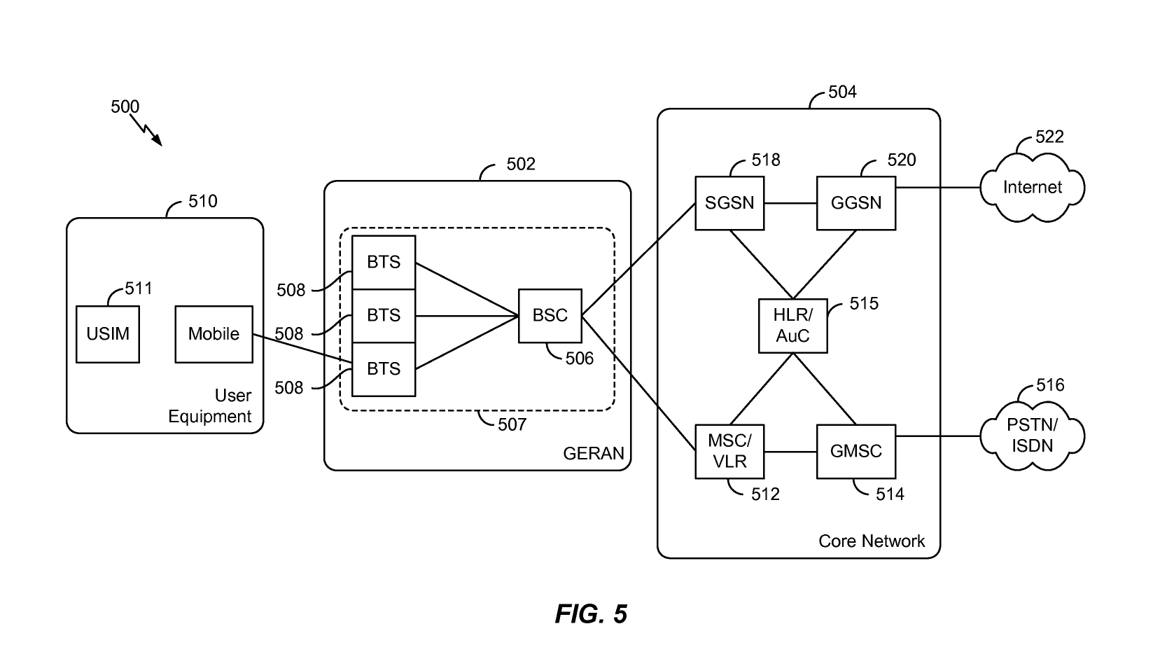

That is, the various concepts presented throughout this disclosure may be implemented across a broad variety of telecommunication systems, network architectures, and communication standards. Referring now to FIG. 5, as an illustrative example without limitation, various aspects of the present disclosure are illustrated with reference to a Global System for Mobile (GSM) system 500. A GSM network includes three interacting domains: a core network 504 (e.g., a GSM/GPRS core network), a radio access network (RAN) (e.g., the GSM/EDGE Radio Access Network (GERAN) 502), and user equipment (UE) 510. In this example, the illustrated GERAN 502 may employ a GSM air interface for enabling various wireless services including telephony, video, data, messaging, broadcasts, and/or other services. The GERAN 502 may include a plurality of Radio Network Subsystems (RNSs) such as an RNS 507, each controlled by a respective Base Station Controller (BSC) such as a BSC 506. Here, the GERAN 502 may include any number of BSCs 506 and RNSs 507 in addition to the illustrated BSCs 506 and RNSs 507. The BSC 506 is an apparatus responsible for, among other things, assigning, reconfiguring, and releasing radio resources within the RNS 507.

The geographic region covered by the RNS 507 may be divided into a number of cells, with a radio transceiver apparatus serving each cell. A radio transceiver apparatus is commonly referred to as a base transceiver station (BTS) in GSM applications, but may also be referred to by those skilled in the art as a base station (BS), a Node B, an eNB, a radio base station, a radio transceiver, a transceiver function, a basic service set (BSS), an extended service set (ESS), an access point (AP), or some other suitable terminology. For clarity, three BTSs 508 are shown in the illustrated RNS 507; however, the RNSs 507 may include any number of wireless BTSs 508. The BTSs 508 provide wireless access points to a GSM/GPRS core network 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a smartwatch, an Internet-of-Things device, or any other similar functioning devices. The UE 510 may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The GSM “Um” air interface generally utilizes GMSK modulation (although later enhancements such as EGPRS, described below, may utilize other modulation such as 8PSK), combining frequency hopping transmissions with time division multiple access (TDMA), which divides a frame into 8 time slots. Further, frequency division duplexing (FDD) divides uplink and downlink transmissions using a different carrier frequency for the uplink than that used for the downlink. Those skilled in the art will recognize that although various examples described herein may refer to GSM Um air interface, the underlying principles are equally applicable to any other suitable air interfaces.

In some aspects of the disclosure, the GSM system 500 may be further configured for enhanced GPRS (EGPRS). EGPRS is an extension of GSM technology providing increased data rates beyond those available in 2G GSM technology. EGPRS is also known in the field as Enhanced Data rates for GSM Evolution (EDGE), and IMT Single Carrier.

Specific examples are provided below with reference to the GERAN system. However, the concepts disclosed in various aspects of the disclosure can be applied to any time-division-based system, such as but not limited to a UMTS system using a TDD air interface, or an e-UTRA system using a TD-LTE air interface. In some examples, AMR narrowband (NB) and/or wideband (WB) may be used in UMTS TDD air interface, and AMR WB may be used in TD-LTE air interface.

The UE 510 includes one or more universal integrated circuit cards (UICC), each of which may run one or more universal subscriber identity module (USIM) application 511. A USIM stores the subscriber's identity, and provides a user's subscription information to a network as well as performing other security and authentication roles. The illustrated UE 510 includes one USIM 511, but those of ordinary skill in the art will understand that this is illustrative in nature only, and a UE may include any suitable number of USIMs. The UICC or USIM may be referred as SIM (subscriber identification module) or SIM card in some literature.

For illustrative purposes, one UE 510 is shown in communication with one BTS 508 in FIG. 5. The downlink (DL), also called the forward link, refers to the communication link from a BTS 508 to a UE 510, and the uplink (UL), also called the reverse link, refers to the communication link from a UE 510 to a BTS 508.

The core network 504 can interface with one or more access networks, such as the GERAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 504 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 504 supports circuit-switched services with a MSC 512 and a GMSC 514. In some applications, the GMSC 514 may be referred to as a media gateway (MGW). One or more BSCs, such as the BSC 506, may be connected to the MSC 512. The MSC 512 is an apparatus that controls call setup, call routing, and UE mobility functions. The MSC 512 also includes a visitor location register (VLR) that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The illustrated core network 504 also supports packet-switched data services with a serving GPRS support node (SGSN) 518 and a gateway GPRS support node (GGSN) 520. General Packet Radio Service (GPRS) is designed to provide packet-data services at speeds higher than those available with standard circuit-switched data services. The GGSN 520 provides a connection for the GERAN 502 to a packet-based network 522. The packet-based network 522 may be the Internet, a private data network, or some other suitable packet-based networks. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

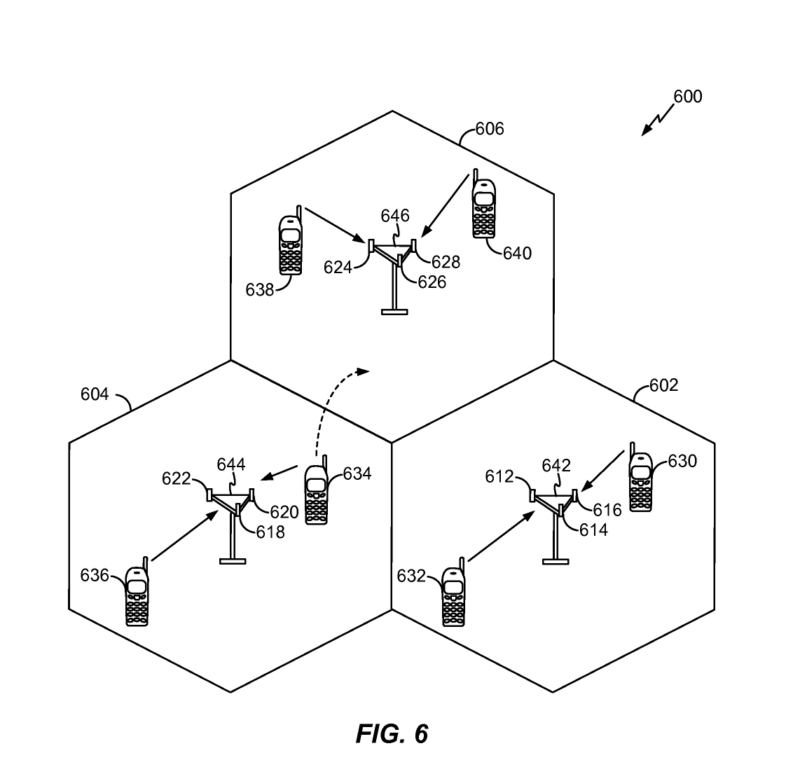

The GERAN 502 is one example of a RAN that may be utilized in accordance with the present disclosure. Referring to FIG. 6, by way of example and without limitation, a simplified schematic illustration of a RAN 600 in a GERAN architecture is illustrated. The system includes multiple cellular regions (cells), including cells 602, 604, and 606, each of which may include one or more sectors. Cells may be defined geographically, e.g., by coverage area. In a cell that is divided into sectors, the multiple sectors within a cell can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 may each correspond to a different sector. In cell 606, antenna groups 624, 626, and 628 may each correspond to a different sector.

The cells 602, 604, and 606 may include several UEs that may be in communication with one or more sectors of each cell 602, 604, or 606. For example, UEs 630 and 632 may be in communication with a BTS 642, UEs 634 and 636 may be in communication with a BTS 644, and UEs 638 and 640 may be in communication with a BTS 646. Here, each BTS 642, 644, and 646 may be configured to provide an access point to a core network 504 (see FIG. 5) for all the UEs 630, 632, 634, 636, 638, and 640 in the respective cells 602, 604, and 606.

FIG. 7 is a block diagram illustrating an example of a hardware implementation for an apparatus 700 employing a processing system 714. In accordance with various aspects of the disclosure, an element, or any portion of an element, or any combination of elements may be implemented with a processing system 714 that includes one or more processors 704. In one example, the apparatus 700 may be the UE illustrated in FIGS. 5 and/or 6. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits or components including one or more processors (represented generally by the processor 704), a memory 705, computer-readable media (represented generally by the computer-readable medium 706), and one or more USIMs (e.g., USIM 511). The bus 702 may also link various other circuits such as timing sources, peripherals, voltage regulators, and power management circuits, which are well known in the art, and therefore, will not be described any further. A bus interface 708 provides an interface between the bus 702 and a communication interface 710. The communication interface 710 may include a transceiver 711 that provides a means for communicating with various other apparatus over a transmission medium. The transceiver 711 may be configured for operation in one or more bands, and may be utilized, for example, to receive both an over-the-air pilot signal and an information signal as desired. The communication interface 710 may further include a mixer 713 that, in some examples, may be the same as the imperfect mixer 200 (see FIG. 2) or 302 (see FIG. 3) described above.

In one aspect of the disclosure, the processor 704 includes an FCCH retrieval block 741 that can be configured to perform operations for receiving an over-the-air tone pilot, including but not limited to the FCCH, as described below in reference to FIGS. 3, 4, and 9. For example, the FCCH retrieval block 741 may be utilized to receive the over-the-air pilot tone upon explicit or implicit instruction, or according to a predetermined schedule for refreshing the RSB parameter estimates. The processor 704 may further include a sampler block 744 for sampling a baseband signal output by a mixer 713 (described below) at a suitable sampling rate to generate a discrete-time version of the baseband signal output by the mixer 713. The processor 704 may further include an RSB parameter estimation block 742 for determining or calculating an estimate of one or more parameters corresponding to the RSB in the baseband signal resulting from the mixer 713. The RSB parameter estimation block 742 may be configured to determine a first RSB parameter estimate α and a second RSB parameter estimate φ, corresponding to differences in amplitude and phase, respectively, of the different branches of the mixer 713. Further details of the calculations that may be performed are provided below. The processor 704 may further include an RSB compensation block 743 for applying the estimated RSB parameters to compensate for the RSB.

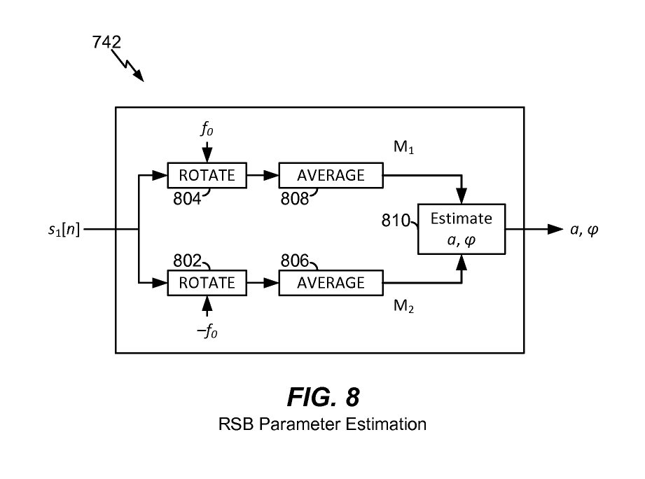

Depending upon the nature of the apparatus, a user interface 712 (e.g., keypad, display, speaker, microphone, joystick, touchpad, touch screen, haptic device) may also be provided. The processor 704 is responsible for managing the bus 702 and general processing, including the execution of software stored on the computer-readable medium 706. The software, when executed by the processor 704, causes the processing system 714 to perform the various functions and processes described in FIGS. 3, 8, and/or 9 for any particular apparatus. In one aspect of the disclosure, the computer-readable storage medium 706 stores software including FCCH retrieval instructions 761 sampler instructions 764, RSB parameter estimation instructions 762, and RSB compensation instructions 763, which when executed by the processor 704, may configure the apparatus 700 to perform the functions described in FIGS. 3, 8, and/or 9. The computer-readable storage medium 706 may also be used for storing data that is manipulated by the processor 704 when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Referring now once again to FIG. 5, in the GERAN 502, a BTS 508 may broadcast a frequency correction channel (FCCH) including a fixed pilot tone at a predefined time-frequency location in the channel. The FCCH is provided for synchronization purposes, such as to enable a UE 510 to obtain a frequency lock for its local oscillator (LO). The FCCH may be considered a continuous sine wave having a frequency of about 67 kHz above the RF carrier center frequency.

According to an aspect of the present disclosure, when operable in a GSM network, RSB parameter estimation may be facilitated by taking samples of the FCCH. That is, with reference to FIG. 3, the input information signal y(t) for generating an estimate of RSB parameters may be a pilot tone broadcasted by the network, such as (but not limited to) the FCCH.

According to a predetermined schedule, a periodic timing, or as needed according to any suitable schedule, a mobile device such as the UE 510 may refresh the RSB parameter estimation according to samples of the FCCH. In this way, once the RSB parameters are refreshed, the UE 510 may utilize the latest RSB parameter estimates for all communications that utilize the imperfect mixer. That is, over time, certain parameters that can affect the RSB may vary. These parameters may include the distance of the RSB from the LO frequency, the band utilized for communication, the gain state, the temperature of the mixer, and other factors. By refreshing the RSB parameter estimates as needed utilizing a channel such as the FCCH, accurate compensation for RSB may be maintained over time.

For example, in one aspect of the disclosure, a suitable refresh rate T₀ may be selected for periodically sampling the FCCH burst and refreshing the RSB parameter estimates. Here, the refresh rate T₀ may be selected in accordance with known or predicted rates of change in temperature or other parameters that affect the RSB. As one example, a refresh rate of once every five seconds may be utilized. In a further example, the refresh rate T₀ may be increased or decreased if desired.

Still further, in addition to or alternative to the periodic refreshing of the RSB parameters, a refresh may be triggered by any suitable event, such as a measured or detected change of one or more conditions that may affect the RSB.

If an FCCH is desired to be used to refresh RSB parameters, it may be desired to utilize samples of a single FCCH to cover an entire GSM channel. That is, as indicated above, the FCCH may be broadcasted at 67 kHz above the RF carrier center frequency. For example, if the effective bandwidth ranges from −100 kHz to +100 kHz, the FCCH appears at 67 kHz. Within the range of the GSM channel, the RSB parameters may vary. However, according to an aspect of the present disclosure, such variation may be relatively small, and accordingly, an estimate of the RSB parameters based on the FCCH may be reasonably accurate for compensation across the entire GSM channel in which the FCCH is broadcast.

In some examples, an FCCH in a desired band may be selected for RSB estimation. That is, GSM may utilize up to four bands, with each band including an FCCH. For each of the four bands, use of the mixer may result in different RSB parameters. Thus, an FCCH may be sampled from within a band in which the device is operating, and RSB parameters may be estimated according to that band's FCCH. By selecting an FCCH for RSB estimation from within the band in which communication will take place, any variation in the characteristics of the RSB may be tracked and more accurately compensated for the desired band.

Here, the FCCH utilized by a UE 510 may be broadcasted from the serving cell, i.e., the BTS 508 with which the UE 510 is currently in communication. However, in another aspect of the disclosure, an FCCH broadcasted from one or more neighbor cells may be utilized for refreshing the RSB parameter estimates. Broadly, as long as it is an FCCH at a suitable frequency, any suitable cell within range of the UE 510 may be utilized as a source for an FCCH for refreshing RSB parameter estimates.

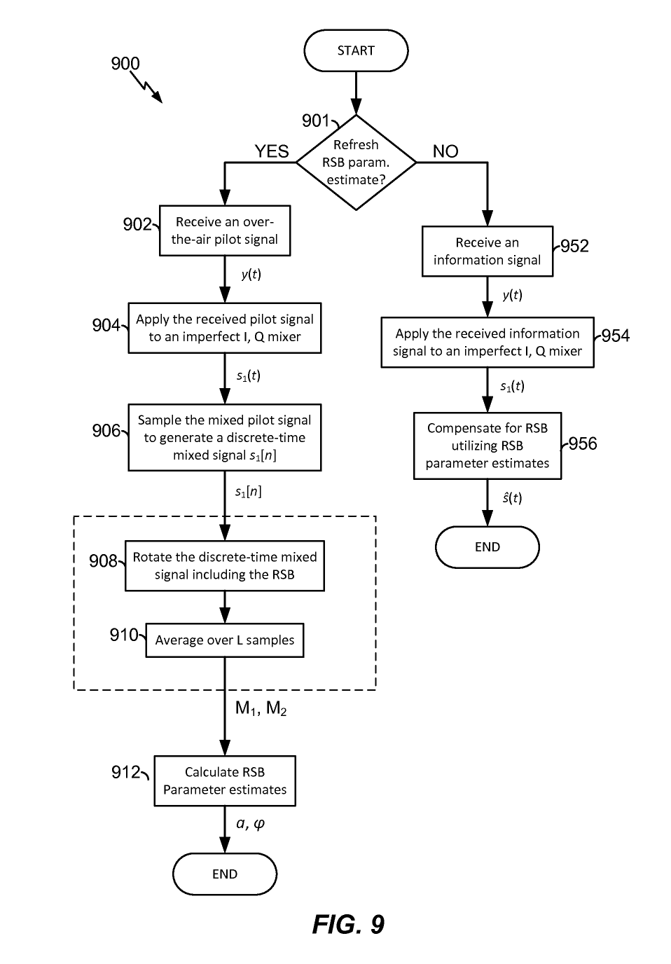

Referring now to FIG. 8, a block diagram is provided to show a more detailed example of an RSB parameter estimation block 742 in accordance with some aspects of the disclosure. FIG. 9 is a flow chart illustrating an exemplary process 900 for generating an estimate of RSB parameters according to an aspect of the disclosure, and is described below in coordination with FIG. 8. The process 900 may be carried out by the UE 700 described above and illustrated in FIG. 7; by a processor (e.g., the processor 704); or by any suitable apparatus or means for carrying out the described functions. In some aspects of the disclosure, the process 900 may be performed for each of a plurality of bands, such that the over-the-air pilot tone (e.g., the FCCH) may be received within a plurality of bands; the RSB parameter estimates may be determined for each of the plurality of bands; and the estimated RSB parameters may be applied to compensate for RSB in each of the plurality of bands.

In the illustration of FIG. 9, a decision block 901 is shown for illustrative purposes, wherein the UE 700 may determine whether or not to refresh the RSB parameter estimate. In a particular implementation, such a decision may be optional or omitted, and, as described above, any suitable trigger or start to the estimation of RSB parameters (e.g., corresponding to blocks 902-912) may be used, including but not limited to a periodic schedule. Here, to illustrate the estimate of the RSB parameters, and the use of the RSB parameters to compensate for the RSB that may appear when mixing a received information signal, the decision block 901 determines whether an estimate is to be determined.

When the RSB parameter estimates are to be refreshed, at block 902, the communication interface 700 (see FIG. 7) may receive an information signal y(t). As indicated above in relation to FIG. 3, an information signal y(t) may correspond to any suitable information received in an over-the-air transmission. In some examples, the information signal y(t) may be an over-the-air tone pilot signal received from a serving cell, a neighbor cell neighboring the serving cell, or any suitable cell. Here, the over-the-air tone pilot signal may be taken from a selected band (e.g., the same band of operation for communication), or from any suitable band. For example, the over-the-air tone pilot may be carried on a frequency correction channel (FCCH).

At block 904, the UE 700 may apply the information signal y(t) (e.g., the received pilot signal) to an imperfect I-Q mixer 713, which mixes the information signal y(t) (e.g., the tone pilot or FCCH) with a local tone at the carrier frequency f_{c}(t), e.g., to downconvert the information signal to baseband. Here, the result of the imperfect mixing is the baseband signal, or mixed information signal s₁(t)=I₁(t)+jQ₁(t), as described above.

At block 906, the UE 700 may provide the baseband signal s₁(t) to a sampler 744, which samples the baseband signal at a suitable sampling rate Fs resulting in the discrete-time version of the baseband signal s₁[n]=I₁[n]+jQ₁[n].

At block 908, the UE 700 may send the discrete-time version of the baseband signal s₁[n] to two rotate blocks 802 and 804 (see FIG. 8). As illustrated, a first rotate block 802 may implement a negative shift corresponding to −f₀, and a second rotate block 804 may implement a positive shift corresponding to +f₀. Here, f₀ corresponds to the frequency of the baseband signal, as illustrated in FIG. 4 and described above. In the frequency domain, this rotation essentially shifts the signal back to DC. Mathematically, the shift may be represented by the multiplication of the discrete-time mixed information signal s₁[n] with

$${e}^{- j2π \frac{{f}_{0}}{Fs}}$$

(for the positive shift) and with

$${e}^{j2π \frac{{f}_{0}}{Fs}}$$

(for the negative shift), where f₀ and Fs are as described above.

At block 910, the UE 700 may send the output of the rotate blocks 802, 804 to average blocks 806, 808 to apply an averaging function to each of the rotated signals. Here, the average blocks may calculate an average over L time domain samples. Mathematically, the average may represented by the function:

$$\frac{1}{L} {\sum }_{n = 0}^{L - 1} {s}_{1} [ n ] \qquad ( 12 )$$

Combining the rotation and averaging described above in relation to the rotate blocks 802, 804 and the average blocks 806, 808 results in the following easily calculated equations approximating for the parameters M₁ and M₂, which are output from the respective average blocks 806, 808:

$$\begin{matrix}{M}_{1} = \frac{1}{L} {\sum }_{n = 0}^{L - 1} {s}_{1} [ n ] * {e}^{- j2π \frac{{f}_{0}}{Fs} n} & ( 13 ) \\ {M}_{2} = \frac{1}{L} {\sum }_{n = 0}^{L - 1} {s}_{1} [ n ] * {e}^{j2π \frac{{f}_{0}}{Fs} n} & ( 14 )\end{matrix}$$

As seen above in Equation 11, representing the frequency-domain equation for S₁(f), representing the output of the imperfect mixer:

M₁=kA (15)

M₂=k*B (16)

Referring again to FIG. 4, these parameters can be considered to represent the respective amplitudes of the desired signal and the RSB signal. Thus, at block 912, the UE 700 may utilize these parameters to calculate the RSB parameter estimates α and φ based on M₁ and M₂, as follows. First, it can be seen that dividing the complex conjugate of M₂ by M₁ causes the k parameters to cancel out.

$$\frac{{M}_{2}^{*}}{{M}_{1}} = \frac{{B}^{*}}{A} = ( \frac{1 - a {e}^{jϕ}}{1 + a {e}^{jϕ}} ) \qquad ( 17 )$$

And solving for αe^{jφ}:

$$a {e}^{jϕ} = ( \frac{{M}_{1} - {M}_{2}^{*}}{{M}_{1} + {M}_{2}^{*}} ) \qquad ( 18 )$$

This equation represents a complex number representing the amplitude and phase imbalance of the imperfect mixer. Taking the amplitude of both sides solves for α.

$$a = ‖ \frac{{M}_{1} - {M}_{2}^{*}}{{M}_{1} + {M}_{2}^{*}} ‖ \qquad ( 19 )$$

Similarly, taking the inverse tangent of both sides solves for φ.

$$ϕ = {tan}^{- 1} ( \frac{{M}_{1} - {M}_{2}^{*}}{{M}_{1} + {M}_{2}^{*}} ) \qquad ( 20 )$$

These calculations may be performed, in various examples, by the estimation block 810 (see FIG. 8), the RSB parameter estimation block 742 in the processor 704 (see FIG. 7), or any suitable software or circuitry for performing the described calculations. Once the RSB parameter estimates are determined, the UE 700 may store the RSB parameter estimates (e.g., α and φ in its memory 705.

Returning to decision block 901, in some instances the UE 700 may determine not to refresh the RSB parameter estimates, but rather to utilize the RSB parameter estimates to compensate for the RSB brought about by the use of an imperfect mixer on a received information signal.

For example, at block 952, the UE 700 may utilize its transceiver 711 to receive an over-the-air information signal y(t). While the information signal y(t) may be any suitable signal, in some examples, the information signal received at block 952 may correspond to a data channel, a control channel, or other channel containing bits of information to be decoded by the UE 700.

At block 954, the UE 700 may apply the received information signal y(t) to an imperfect I,Q mixer such as the mixer 713. As discussed above, the application to the imperfect mixer may result in an undesired RSB.

Accordingly, at block 956, the UE 700 may compensate for the RSB by utilizing the RSB parameter estimates stored in its memory 705. The compensation may correspond to a mathematical calculation applied to the mixed information signal s₁(t).

The compensation procedure may utilize any suitable algorithm or calculation to apply the RSB parameter estimates (e.g., a and) to reduce or eliminate the RSB resulting from the use of the imperfect mixer. According to one example, the RSB parameter estimates, retrieved from the memory 705, may be utilized to manipulate equation 3 above (corresponding to the output s₁(t) from the imperfect I,Q mixer 200/302/713) to go back to equation 2 above, corresponding to the output of the ideal mixer output s(t), as follows.

s₁(t)=I(t)+jα(l(t)sin φ+Q(t)cos φ) (21)

The quadrature part of this equation, uncompensated, can be represented as follows:

α(l(t)sin φ+Q(t)cos φ) (22)

Compensated, utilizing the RSB parameter estimates obtained as discussed above, the quadrature part of this equation becomes:

$$\frac{a ( I ( t ) sin ϕ + Q ( t ) cos ϕ )}{a cos ϕ} - I ( t ) tan ϕ = ( \frac{I ( t ) sin ϕ}{cos ϕ} + Q ( t ) ) - I ( t ) tan ϕ = I ( t ) tan ϕ + Q ( t ) - I ( t ) tan ϕ = Q ( t )$$

Accordingly, as shown above, the RSB parameter estimates may be utilized to manipulate the output of the non-ideal mixer, s₁(t), to arrive essentially at s(t)=I(t)+jQ(t).

Testing results show that the quality of the estimates of the RSB parameters generally improve as the signal-to-noise ratio SNR improves. Accordingly, with improved RSB parameter estimates, it may occur that, in good SNR conditions, bit errors and other negative effects of the RSB can be substantially improved by utilizing the herein described RSB compensation algorithms. However, even in poor SNR conditions, compensation for RSB utilizing the herein described algorithms can provide benefits, e.g., in terms of a reduction in bit error rates.

Several aspects of a telecommunications system have been presented with reference to a GERAN system. As those skilled in the art will readily appreciate, various aspects described throughout this disclosure may be extended to or implemented in other telecommunication systems, network architectures and communication standards.

By way of example, various aspects may be extended to or implemented in systems employing UMTS (FDD, TDD), Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. wherein the receiving the over-the-air tone pilot comprises receiving a plurality of over-the-air tone pilots corresponding to the plurality of bands;
wherein the determining an estimate comprises determining estimates of one or more parameters corresponding to an RSB resulting from the applying of the mixer for each of the plurality of bands; and
wherein the applying the estimated stored estimate of one or more parameters comprises applying the stored estimate of one or more parameters to compensate for the RSB in each of their respective bands.

6. The method of claim 1, further comprising refreshing the estimate of the one or more parameters by receiving the over-the-air tone pilot in accordance with a refresh rate.

7. The method of claim 6, wherein the refresh rate corresponds to a predicted rate of change of temperature at the UE.

8. The method of claim 1, wherein the one or more parameters corresponding to the RSB in the baseband signal comprise a first RSB parameter estimate α, corresponding to a difference in amplitude between different branches of the mixer, and a second RSB parameter estimate φ, corresponding to a difference in phase between the different branches of the mixer.

9. The method of claim 8, wherein the determining the estimate of one or more parameters comprises:
sampling the baseband signal to generate a discrete-time baseband signal s₁[n], where n represents a sample index;
rotating the discrete-time baseband signal s₁[n] by multiplying samples of the discrete-time baseband signal with a first complex exponential corresponding to a frequency of the baseband signal, and a second complex exponential corresponding to a negative of the frequency of the baseband signal; and
calculating a first average of the samples of the discrete-time baseband signal after the rotating corresponding to the first complex exponential, and a second average of the samples of the discrete-time baseband signal after the rotating corresponding to the second complex exponential.

10. The method of claim 9, wherein the determining the estimate of one or more parameters comprises:
calculating a first parameter M₁ comprising:
$${M}_{1} = \frac{1}{L} {\sum }_{n = 0}^{L - 1} {s}_{1} [ n ] * {e}^{- j2π \frac{{f}_{0}}{Fs} n}$$
calculating a second parameter M₂ comprising:
$${M}_{2} = \frac{1}{L} {\sum }_{n = 0}^{L - 1} {s}_{1} [ n ] * {e}^{j2π \frac{{f}_{0}}{Fs} n}$$
wherein L is a number of samples, and
wherein f₀ is the frequency of the baseband signal;
calculating the first RSB parameter estimate α as:
$$a = ‖ \frac{{M}_{1} - {M}_{2}^{*}}{{M}_{1} + {M}_{2}^{*}} ‖ ;$$
and
calculating the second RSB parameter estimate φ as:
$$ϕ = {tan}^{- 1} ( \frac{{M}_{1} - {M}_{2}^{*}}{{M}_{1} + {M}_{2}^{*}} ) .$$

11. A user equipment (UE) configured for wireless communication, comprising:
at least one processor;
a transceiver communicatively coupled to the at least one processor; and
a memory communicatively coupled to the at least one processor,
wherein the at least one processor and the memory are configured to:
receive an over-the-air tone pilot;
apply the received over-the-air tone pilot to a mixer for mixing the tone pilot with a local tone to generate a baseband signal;
determine an estimate of one or more parameters corresponding to a residual side band (RSB) in the baseband signal resulting from the mixer;
store the estimate of one or more parameters in the memory;
receive an over-the-air information signal;
retrieve the stored estimate of one or more parameters; and
apply the stored estimate of one or more parameters to compensate for the RSB,
wherein the at least one processor and the memory, being configured to apply the stored estimate of one or more parameters, are further configured to compensate for the RSB resulting from application of the over-the air information signal to the mixer.

12. (canceled)

13. The UE of claim 11, wherein the over-the-air tone pilot comprises a frequency correction channel (FCCH) in a global system for mobile (GSM) network.

14. The UE of claim 11, wherein the over-the-air tone pilot is received from one or more neighbor cells neighboring a serving cell for the UE.

15. The UE of claim 11, wherein the at least one processor and the memory are further configured to communicate utilizing a plurality of bands,
wherein the at least one processor and memory, being configured to receive the over-the-air tone pilot, are further configured to receive a plurality of over-the-air tone pilots corresponding to the plurality of bands;
wherein the at least one processor and memory, being configured to determine an estimate, are further configured to determine estimates of one or more parameters corresponding to an RSB resulting from the applying of the mixer for each of the plurality of bands; and
wherein the at least one processor and memory, being configured to apply the stored estimate of one or more parameters, are further configured to apply the stored estimate of one or more parameters to compensate for the RSB in each of their respective bands.

16. The UE of claim 11, wherein the at least one processor and the memory are further configured to refresh the estimate of the one or more parameters by receiving the over-the-air tone pilot in accordance with a refresh rate.

17. The UE of claim 16, wherein the refresh rate corresponds to a predicted rate of change of temperature at the UE.

18. The UE of claim 11, wherein the one or more parameters corresponding to the RSB in the baseband signal comprise a first RSB parameter estimate α, corresponding to a difference in amplitude between different branches of the mixer, and a second RSB parameter estimate φ, corresponding to a difference in phase between the different branches of the mixer.

19. The UE of claim 18, wherein the at least one processor, being configured to determine the estimate of one or more parameters, are further configured to:
sample the baseband signal to generate a discrete-time baseband signal s₁[n], where n represents a sample index;
rotate the discrete-time baseband signal s₁[n] by multiplying samples of the discrete-time baseband signal with a first complex exponential corresponding to a frequency of the baseband signal, and a second complex exponential corresponding to a negative of the frequency of the baseband signal; and
calculate a first average of the samples of the discrete-time baseband signal after the rotating corresponding to the first complex exponential, and a second average of the samples of the discrete-time baseband signal after the rotating corresponding to the second complex exponential.

20. The UE of claim 19, wherein the at least one processor, being configured to determine the estimate of one or more parameters, are further configured to:
calculate a first parameter M₁ comprising:
$${M}_{1} = \frac{1}{L} {\sum }_{n = 0}^{L - 1} {s}_{1} [ n ] * {e}^{- j2π \frac{{f}_{0}}{Fs} n}$$
calculate a second parameter M₂ comprising:
$${M}_{2} = \frac{1}{L} {\sum }_{n = 0}^{L - 1} {s}_{1} [ n ] * {e}^{j2π \frac{{f}_{0}}{Fs} n}$$
wherein L is a number of samples, and
wherein f₀ is the frequency of the baseband signal;
calculate the first RSB parameter estimate α as:
$$a = ‖ \frac{{M}_{1} - {M}_{2}^{*}}{{M}_{1} + {M}_{2}^{*}} ‖ ;$$
and
calculate the second RSB parameter estimate φ as:
$$ϕ = {tan}^{- 1} ( \frac{{M}_{1} - {M}_{2}^{*}}{{M}_{1} + {M}_{2}^{*}} ) .$$

21. A user equipment (UE) configured for wireless communication, comprising:
means for receiving an over-the-air tone pilot;
means for applying the received over-the-air tone pilot to a mixer for mixing the tone pilot with a local tone to generate a baseband signal;
means for determining an estimate of one or more parameters corresponding to a residual side band (RSB) in the baseband signal resulting from the mixer;
means for storing the estimate of one or more parameters;
wherein the means for receiving is further configured to receive an over-the-air information signal;
means for retrieving the stored estimate of one or more parameters; and
means for applying the stored estimate of one or more parameters to compensate for the RSB,
wherein the means for applying the stored estimate of one or more parameters is configured for compensating for the RSB resulting from application of the over-the-air information signal to the mixer.

22. (canceled)

23. The UE of claim 21, wherein the over-the-air tone pilot comprises a frequency correction channel (FCCH) in a global system for mobile (GSM) network.

24. The UE of claim 21, further comprising means for refreshing the estimate of the one or more parameters by receiving the over-the-air tone pilot in accordance with a refresh rate.

25. The UE of claim 24, wherein the refresh rate corresponds to a predicted rate of change of temperature at the UE.

26. A non-transitory computer-readable medium storing computer-executable code, comprising instructions for causing a user equipment (UE) to:
receive an over-the-air tone pilot;
apply the received over-the-air tone pilot to a mixer for mixing the tone pilot with a local tone to generate a baseband signal;
determine an estimate of one or more parameters corresponding to a residual side band (RSB) in the baseband signal resulting from the mixer;
store the estimate of one or more parameters in a memory;
receive an over-the-air information signal;
retrieve the stored estimate of one or more parameters; and
apply the stored estimate of one or more parameters to compensate for the RSB,
wherein the instructions for causing the UE to apply the stored estimate of one or more parameters are configured for compensating for the RSB resulting from application of the over-the-air information signal to the mixer.

27. (canceled)

28. The non-transitory computer-readable medium of claim 26, wherein the over-the-air tone pilot comprises a frequency correction channel (FCCH) in a global system for mobile (GSM) network.

29. The non-transitory computer-readable medium of claim 26, further comprising instructions for causing the UE to refresh the estimate of the one or more parameters by receiving the over-the-air tone pilot in accordance with a refresh rate.

30. The non-transitory computer-readable medium of claim 29, wherein the refresh rate corresponds to a predicted rate of change of temperature at the UE.
